(19) United States
(12) Patent Application Publication
(10) Pub. No.: US 2026/0057097 A1
(43) Pub. Date: Feb. 26, 2026

(54) IDENTITY AND ACCESS MANAGEMENT ENABLED ONLINE PROMPT DRIVEN ANALYTICAL MODEL AND EXTRACT TRANSFORM TO DOCUMENT LOAD

(71) Applicant: Dell Products L.P., Round Rock, TX (US)

(72) Inventors: Thirumaleshwara Adyanadka Shama, Austin, TX (US); Shibi Panikkar, Bangalore (IN)

(21) Appl. No.: 18/812,751

(22) Filed: Aug. 22, 2024

(51) Int. Cl. G06F 21/62; G06F 16/22; G06F 16/28

(52) U.S. Cl. CPC G06F 21/6227; G06F 16/2237; G06F 16/282

(57) ABSTRACT

A method for managing data access includes obtaining, by a data system, a structured database from an order processing system, wherein the structured database comprises data associated with a large set of users, identifying persona boundaries, performing a transform-to-document process on the structured database based on a configuration to generate a set of vectorized documents, wherein each of the set of vectorized documents corresponds to one of the persona boundaries, performing a graph embedding on the set of vectorized documents to obtain a hierarchical database, loading the set of vectorized documents and the hierarchical database to an online prompt-driven analytical processing (OPAP) model of the data system, and using the OPAP model and an identity and access management (IAM) system to manage access to the data by a user based on the persona boundaries, wherein the IAM system maps the user to a persona boundary of the persona boundaries.

### BACKGROUND

Generative artificial intelligence (AI) is in high demand by enterprises accessing large databases and applications that store large amounts of data. Using AI by a user to access such data runs the risk of providing information not intended to be accessed by the user. For example, enterprise transactional data may be stored in structured databases, and it may be difficult for an AI model (such as a large language model) to understand the structured databases sufficiently to provide requested data while implementing identity and access management. Additionally, data security in a structured database associated with multiple users is a challenge.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments of the invention.

FIG. 1.2 shows a diagram of a hierarchical database in accordance with one or more embodiments of the invention.

FIG. 1.3 shows a diagram of a vectorized document in accordance with one or more embodiments of the invention.

FIG. 2.1 shows a flowchart of a method of performing an extract transform-to-document process in accordance with one or more embodiments of the invention.

FIG. 2.2 shows a flowchart of a method of generating a vectorized document in accordance with one or more embodiments of the invention.

FIG. 3 shows a flowchart of a method of using an online prompt-driven analytical model (OPAP) in accordance with one or more embodiments of the invention.

FIG. 4.1-4.1 show an example in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

Embodiments disclosed herein include a solution for implementing identity and access management (IAM) while providing user queries for structured databases. The structured databases may include, for example, online transaction processing (OLTP) or online analytical processing (OLAP) systems. Embodiments disclosed herein include system and methods of converting the structured OLTP/OLAP data model-based data to large language models (LLM) aware language model with data segregation of the data to vectorized documents based on persona boundaries. The persona boundaries may be defined based on, for example, a “Differentiating Entity”, a “Sub-Entity”, a “Context” and a “Sub-Context”. Such systems and methods include using an extract transform-to-document Load (ETDL) process. Differentiating Entity may refer to a customer or an identifying user of the system. Context may refer to, for example, a specified use case for a domain of the data being requested. Examples of contexts include, but are not limited to: order or subscription and healthcare information. Sub Context may refer to a subsection of a context, such as, for example, enterprise subscription and consumer subscription. The documents that are produced at the leaf level are on a per-persona boundary (Differentiating Entity/Context/SubContext) basis.

Embodiments disclosed herein include a data driven approach to control the documents that is accessible to the logged in user in the system initiating queries in an IAM system. The system will load those documents that the logged in user as intended to access and allow the LLM to give answers based primarily on those loaded documents. For example, if a system includes data of ten persona boundaries (e.g., users) in the vectorized documents, each user may obtain information only about its corresponding data. The system for generating and storing the smallest fragment of documents based on the persona boundary (e.g., the combination of a differentiating entity, context, and sub-context) is referred to as an online prompt-driven analytical processing (OPAP) model. The OPAP model may be a vector representation of this smallest fragment for an enterprise tree leaf, a graph database or any other hierarchical database driving the IAM activities to identify the authorized and accessible vector representation of the document fragment.

To implement the IAM driven access of the OPAP model, a process is used for extracting the relevant identified documents. The process may be referred to as the extract transform-to-document Load (ETDL) process.

The following describes various embodiments of the invention.

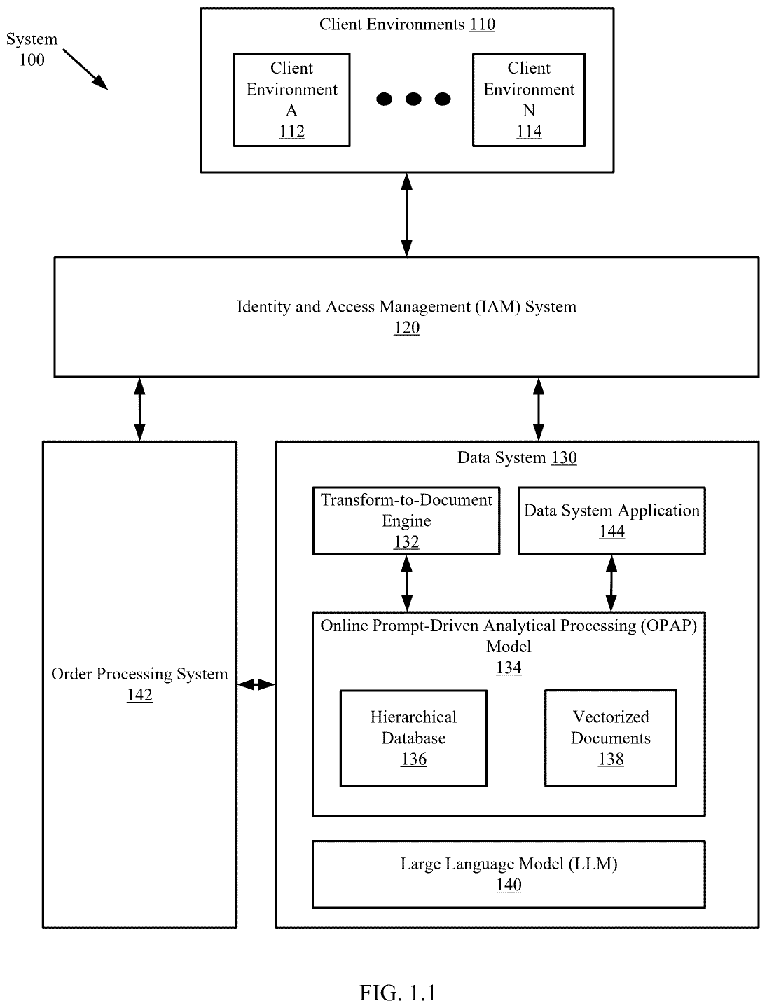

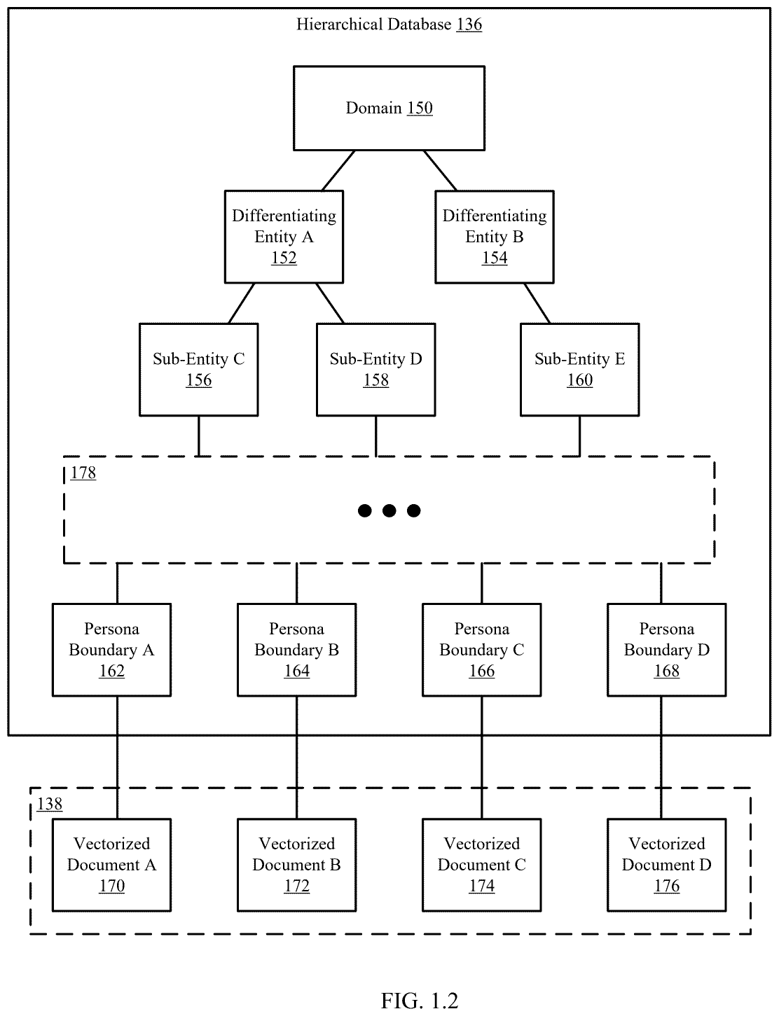

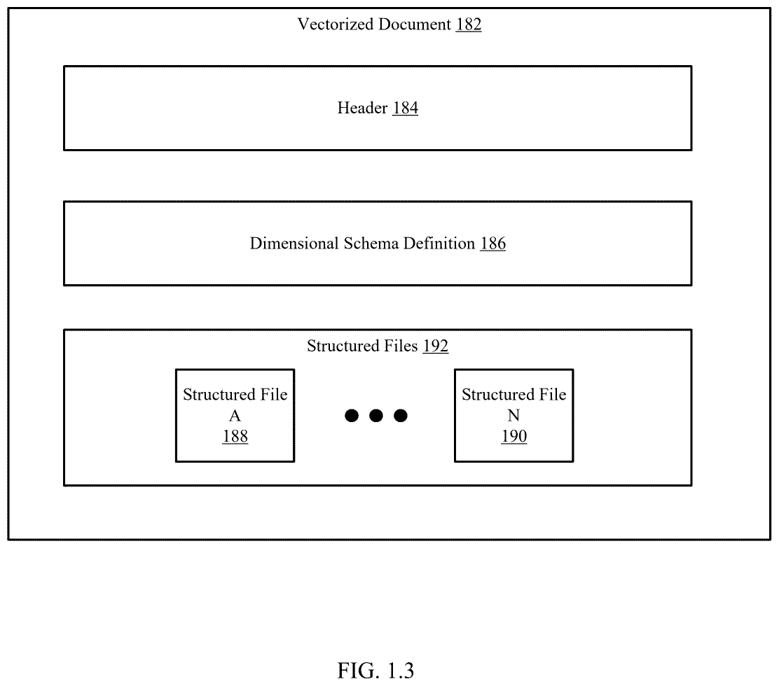

FIG. 1.1 shows a system in accordance with one or more embodiments of the invention. The system (100) includes any number of client environments (110), a data system (130), an order processing system (142), and an identity and access management (IAM) system (120). The overall system (100) may include additional, fewer, and/or different components without departing from the scope of the invention. Each component may be operably connected to any of the other component via any combination of wired and/or wireless connections. Each component illustrated in FIG. 1.1 is discussed below.

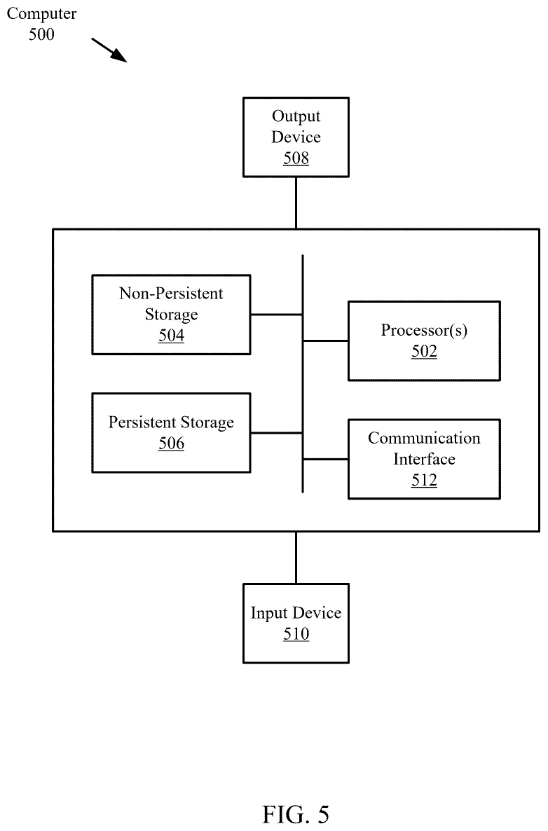

In one or more embodiments, each client environment (112, 114) is implemented as one or more computing devices (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the client environment (112, 114) described throughout this present disclosure.

In one or more embodiments of the invention, each client environment (112, 114) is implemented as a logical device. A logical device may utilize the computing resources of any number of computing devices (refer to FIG. 5) to provide the functionality of the client environment (112, 114) described throughout this present disclosure.

In one or more embodiments, each client environment (112, 114) represents an organization (e.g., an enterprise) that includes any number of users managing data online using an order processing system (142). The users may access the data via computing devices of the respective client environments (112, 114).

For example, a user of a client environment (e.g., 112) may generate data using an application of the client environment (112) and store the data in the order processing system (142). The data may be, for example, transactional information associated with a transaction between the organization of the client environment (112) and an owner of the order processing system (142). For a second organization operating in another client environment (e.g., 114), the data managed by the second organization in the order processing system (142) may be, for example, medical information of patients serviced by the second organization that is stored in the order processing system (142). In this example, both organizations may utilize the same order processing system (142) to manage their respective data.

To differentiate between the multiple organizations managing data in an order processing system, embodiments of the invention may utilize an IAM system (120). In one or more embodiments, the IAM system (120) may store user credentials for all of the organizations in the client environments (110). The IAM system (120) may include functionality for authorizing user credentials and determining the authenticity of a user for the purposes of identification and data access. For example, the IAM system (120) may be used to determine the data to be provided access to by each computing device of the client environments (110).

In one or more embodiments, the IAM system (120) is implemented as a computing device (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the IAM system (120) described throughout this present disclosure.

Alternatively, in one or more embodiments of the invention, the IAM system (120) is implemented as a logical device. A logical device may utilize the computing resources of any number of computing devices to provide the functionality of the IAM system (120) described throughout this present disclosure.

As discussed above, the order processing system (142) may include functionality for storing data managed by organizations of the client environments (110). In one or more embodiments, the order processing system (142) may provide data storage, data organizational services, data access management, and/or any other data services without departing from the invention. The order processing system (142) may include a structured database (not shown) that includes the data of any organizations using the order processing system (142) for data management.

In one or more embodiments, the order processing system (142) is implemented as an online transaction processing (OLTP) service or an online analytical processing (OLAP) system. The OLTP and OLAP services may each be a system for database management in uni-or multi-dimensional models. The order processing systems (142) may provide the data to the organizations in the client environments (110) and provide analytical services of the corresponding data.

In one or more embodiments, the order processing system (142) is implemented as a computing device (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the order processing system (142) described throughout this present disclosure.

Alternatively, in one or more embodiments of the invention, the order processing system (142) is implemented as a logical device. A logical device may utilize the computing resources of any number of computing devices to provide the functionality of the order processing system (142) described throughout this present disclosure.

In one or more embodiments, the order processing system (142) may provide limited services for querying the data. For example, in current implementations of the order processing system (142) and without using embodiments of the invention, the order processing system (142) may not provide the functionality for obtaining user queries from the client environments (110) in a natural language (e.g., a language naturally used by humans) and accessing only the relevant data to a given user (i.e., without using data from other organizations) to respond to such user queries and to respond in the natural language.

In one or more embodiments, the data system (130) provides the functionality for: (i) obtaining user queries for data in an order processing system (142) in a natural language, (ii) processing the user query using only data intended to be accessible by the corresponding entity, and (iii) providing a response in the natural language. To perform the aforementioned functionality, the data system (130) includes a transform-to-document engine (132), a data system application (144), an online prompt-driven analytical processing (OPAP) model, and a large language model (140). The data system may include additional, fewer, and/or different components without departing from the invention.

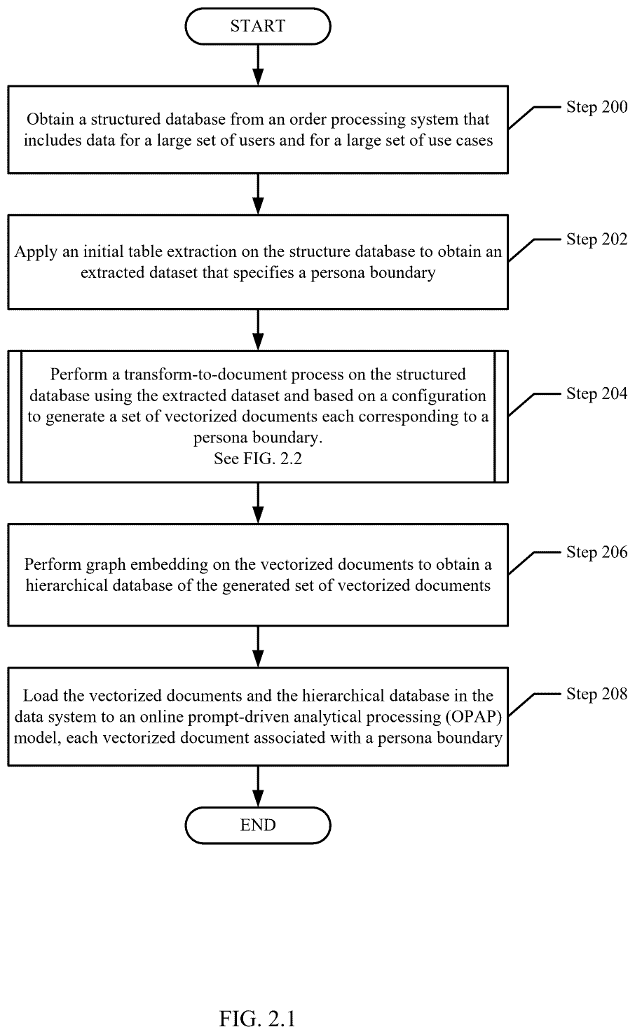

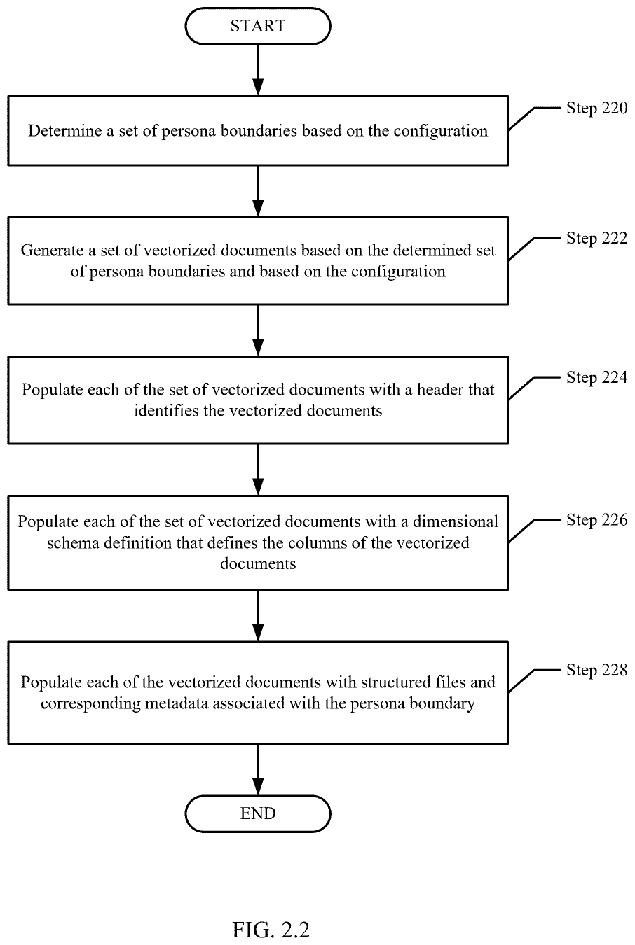

In one or more embodiments, the transform-to-document engine (132) includes functionality for obtaining the data in the order processing system (142) and generating the vectorized documents (138) for the OPAP model (134). The OPAP model (134) may be generated, for example, in accordance with the methods of FIG. 2.1-2.2.

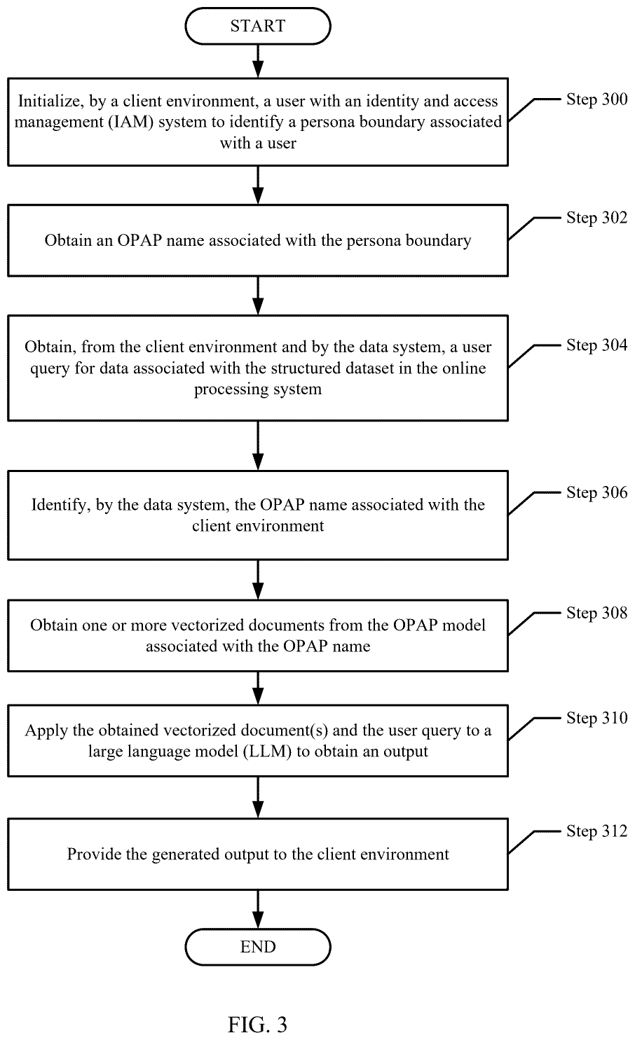

In one or more embodiments, the data system application (144) includes functionality for obtaining user queries and processing the user queries using the OPAP model (134) and the LLM (140) to generate an output. The processing of user queries may be performed, for example, in accordance with the method of FIG. 3.

In one or more embodiments, the OPAP model (134) is a data structure that segregates data obtained from the order processing system (142) based on a persona boundary (discussed below in FIG. 1.2 and 1.3). The OPAP model (134) includes a hierarchical database (136) and a set of vectorized documents (138). For additional details regarding the hierarchical database (136), refer to FIG. 1.2. For additional details regarding one of the set of vectorized documents (138), refer to FIG. 1.3.

In one or more embodiments, the LLM (140) is a machine learning model that obtains inputs that include: (i) user queries written in a natural language and (ii) one or more of the vectorized documents (138). The LLM (140) may output a response to the user query, using the content of the inputted one or more vectorized documents (138). The output may be in a natural language. The LLM (140) may be implemented using any machine learning algorithm (e.g., convolutional neural network (CNN), generative AI, etc.) without departing from the invention.

In one or more embodiments, the data system (130) (and/or each component illustrated within) is implemented as a computing device (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the data system (130) (and/or each component illustrated within) described throughout this present disclosure including the methods of FIG. 2.1, 2.2, and 3.

Alternatively, in one or more embodiments of the invention, the data system (130) (and/or each component illustrated within) is implemented as a logical device. A logical device may utilize the computing resources of any number of computing devices to provide the functionality of the data system (130) (and/or each component illustrated within) described throughout this present disclosure including the methods of FIG. 2.1, 2.2, and 3.

To further clarify the hierarchical database (136) discussed above, an example hierarchical database is illustrated in FIG. 1.2. The hierarchical database described using FIG. 1.2 may be at least one embodiment of the hierarchical database (136) discussed throughout this disclosure.

In one or more embodiment, the hierarchical database (136) may be an organization of relationships between components of a defined persona boundary (e.g., 162). The component at the highest level of the hierarchical database may be a domain (150). The domain (150) may be a data structure that uniquely identifies an organizational entity (also referred to as an organization) that owns the order processing system (138, FIG. 1.1) (or otherwise manages the data stored in the order processing system) discussed above. The domain (150) may represent the organization.

In one or more embodiments, other organizations that interact with the organization of the domain (150) may be referred to as differentiating entities (152, 154). The domain (150) may interact with any number of differentiating entities (152, 154). Each differentiating entity (152, 154) may interact with the domain (150) by performing transactions with the domain (150) to purchase computing hardware, or services such as, for example, data storage, data management services (via the order processing system), software services, and/or other services without departing from the invention.

Based on the multiple interactions between the domain (150) and each differentiating entity (152, 154), additional segregations of the differentiating entities (152, 154) may be performed to obtain sub-entities (156, 158, 160). The sub-entities may be in a next level lower in the hierarchical database (136). Further segregation of the sub-entities (156, 158, 160) may be performed to obtain additional levels (178) in the organization of the hierarchical database (136). The configuration of the levels in the hierarchical database (136) is described in the description of FIG. 2.1 and 2.2.

The components defined in the lowest level of the hierarchical database (136) are the persona boundaries (162, 164, 166, 168). In one or more embodiments, a persona boundary (162, 164, 166, 168) is the narrowest definition of an entity used for the generation of the vectorized documents (138). Each persona boundary (162, 164, 166, 168) is defined by one differentiating entity (152, 154) and a narrowest relationship of lower-level components such as, for example, sub-entities (156, 158, 160) or lower (178).

To further clarify the relationship between components and levels organized in the hierarchical database (136), consider a scenario in which a differentiating entity (e.g., 152) is a medical organization such as a hospital. The medical organization may subscribe to data management services provided by the domain (150) to store both patient data and drug trial data. As such, the medical organization may include various types of users such as doctors, patients, research scientists, administrators, and/or other types of users without departing from the invention. Each user in the medical organization may utilize a computing device to access data management services owned by an owner of the domain (150). The hierarchical database (136) in this scenario may be configured to include a first sub-entity (e.g., 156) to be drug-trial data of the medical organization and a second sub-entity (158) to be patient information. Further, a second differentiating entity (154) represents an airplane manufacturing company. The airline manufacturing company interacts with the domain (150) by purchasing computing hardware offered by the owner representing the domain (150). The sub-entity (160) for the airline manufacturing company may include order transaction information.

In the above scenario, a first persona boundary (162) may be configured to represent a leaf of the hierarchical database (150) that links the domain (150) to the medical organization to the drug trial data; a second persona boundary (164) may represent a leaf that links the domain (150) to the medical organization to the patient information; and a third persona boundary (166) links the domain (150) to the airline manufacturing company to the order transaction information.

Continuing with the description of FIG. 1.2, the vectorized documents (138) represent information about the order processing system segregated based on the persona boundaries (162, 164, 166, 168) of the hierarchical database (136). Each vectorized document (170, 172, 174, 176) includes information about only the corresponding persona boundary (162, 164, 166, 168).

In one or more embodiments, each persona boundary (162, 164, 166, 168) may specify a document identifier of the corresponding vectorized document (170, 172, 174, 176), a vector index of each corresponding vectorized document (170, 172, 174, 176), an identifier of the persona boundary (also referred to herein as an OPAP name), and identifiers of the components for defining the persona boundary (162, 164, 166, 168). For additional details regarding the vectorized documents, refer to FIG. 1.3.

FIG. 1.3 shows a diagram of a vectorized document in accordance with one or more embodiments of the invention. The vectorized document (182) may be an embodiment of a vectorized document (170, 172, 174, 176, FIG. 1.2) discussed above. The vectorized document (182) may include a header (184), a dimensional schema definition (186), and one or more structured files (192). The vectorized document (182) may include additional, fewer, and/or different components without departing from the invention.

In one or more embodiments of the invention, the header (184) is a data structure that identifies the common features of the vectorized document. The header (184) may be written in a natural language and include the common features of the corresponding persona boundary. An example header includes the following text: “This document contains all subscriptions made by Boeing, from Dell as customer in JSON format. Customer Number is 1837734.” In this text, the persona boundary is defined based on an organization (“Boeing”), the domain (“Dell”), and using a customer number. The example text further describes that the structured files (188, 190) of the vectorized document (182) are formatted as JSON files.

While embodiments of the invention define the header (184) as being written in a natural language, the header (184), and any component of the vectorized document (184), may be written in a format readable to a large language model (LLM) for the purposes of extracting requested data.

In one or more embodiments, the dimensional schema definition (186) is a data structure that specifies definitions of metadata specified in the structured files (192). The structured files may be generated using a natural language template that repeats a structure of presenting the data in the vectorized document (184). The structure of the structured files may be in a JSON format, YAML, natural language template, or any other format without departing from the invention.

In one or more embodiments, the structured files (192) may be updated based on changes made to the structured database of the order processing system (142, FIG. 1.1). As the data of the order processing system changes, the corresponding vectorized document (184) may be updated by updating the structured files (192) with the corresponding data.

FIG. 2.1 shows a flowchart of a method of performing an extract transform-to-document process in accordance with one or more embodiments of the invention. The method shown in FIG. 2.1 may be performed by, for example, a data system (e.g., 130, FIG. 1.1). Other components of the system in FIG. 1.1 may perform all, or a portion, of the method of FIG. 2.1 without departing from the invention.

While FIG. 2.1 is illustrated as a series of steps, any of the steps may be omitted, performed in a different order, additional steps may be included, and/or any or all of the steps may be performed in a parallel and/or partially overlapping manner with other steps in other methods without departing from the invention.

Turning to FIG. 2.1, in step 200, a structured database is obtained from an order processing system. The structured database may include data for a large set of users for a large set of organizations. Further, there may be a variety of use cases by each organization. For example, one organization may perform transactions with an owner, and also purchase subscriptions for a data management service. Both information about the transactions and the data management services are stored in the structured database. The two use cases for this one organization include the transactions and the data management service.

In step 202, an initial table extraction is performed on the structured database to obtain an extracted dataset. In one or more embodiments, the initial table extraction includes determining the dimensions (e.g., the columns) of the structured database and organizing each dimension in the extracted dataset such that additional information about each dimension is captured in the extracted dataset. The additional information may include, for example, whether a column may be used to represent a differentiating entity (or another component of a persona boundary). For example, one of the columns in the structured database may specify an organization identifier. The extracted dataset may indicate that this one column may be used to identify the differentiating entities. This identification may be performed for each component for the persona boundaries.

In step 204, a transform-to-document process is performed on the structured database using the extracted dataset and based on a configuration to generate a set of vectorized documents each corresponding to a persona boundary. In one or more embodiments, the transform-to-document process includes using a transform-to-document engine (132, FIG. 1.1) to determine the persona boundaries (see FIG. 1.3) for the system, and generating at least one vectorized document for each determined persona boundary. Additional vectorized documents may be generated for one persona boundary based on, for example, a size threshold for vectorized documents. The configuration of the transform-to-document process may specify the number of levels in the hierarchical database (e.g., based on a desired granularity of segregation). The transform-to-document process may be performed, for example, using the method of FIG. 2.2.

In step 206, a graph embedding is performed on the vectorized documents to obtain a hierarchical database. In one or more embodiments, the graph embeddings includes determining a hierarachical path of each vectorized document based on its corresponding persona boundary. The graph embedding further includes generating the hierarchical database to track the organization of components as configured using the configuration. The graph embedding may result in the generation of the hierarchical database and an indexing of the vectorized documents in the hierarchical database.

In step 208, the OPAP model is generated by loading the set of vectorized documents and the hierarchical database into the OPAP model. The OPAP model may be used for servicing user queries that include messages written in a natural language. The processing of such user queries may be performed, for example, using the method of FIG. 3.

FIG. 2.2 shows a flowchart of a method of generating a vectorized document in accordance with one or more embodiments of the invention. The method shown in FIG. 2.2 may be performed by, for example, a data system (e.g., 130, FIG. 1.1). Other components of the system in FIG. 1.1 may perform all, or a portion, of the method of FIG. 2.2 without departing from the invention.

While FIG. 2.2 is illustrated as a series of steps, any of the steps may be omitted, performed in a different order, additional steps may be included, and/or any or all of the steps may be performed in a parallel and/or partially overlapping manner with other steps in other methods without departing from the invention.

In step 220, a set of persona boundaries are determined based on a configuration. In one or more embodiments, the persona boundaries are determined by identifying the number of levels specified in the configuration to be applied to the hierarchical database, identifying the components and sub-components of the organization of the hierarchical database, and identifying the leaf-level components (e.g., the persona boundaries) that result from the configuration and the identification of the components.

In step 222, a set of vectorized documents are generated based on the determined set of persona boundaries and based on the configuration. In one or more embodiments, each of the set of vectorized documents is generated to correspond to one of the persona boundaries. Each vectorized document is indexed for access purposes (e.g., by the IAM system). A document identifier is generated for each of the set of vectorized documents that uniquely identifies the corresponding document.

In step 224, each of the set of vectorized documents are populated with a header that identifies the vectorized documents. In one or more embodiments, the header includes a natural language description of the contents of the corresponding vectorized document.

In step 226, each of the set of vectorized documents is populated with a dimensional schema definition. In one or more embodiments, the dimensional schema definition includes definitions of each dimension included in the corresponding vectorized document.

In step 228, each vectorized document is populated with structured files and corresponding metadata associated with the persona boundary. In one or more embodiments, the structured files include the data that is intended to be accessible by the corresponding persona boundary of the vectorized documents. The structured files may be obtained from the structured database of the order processing system. The structured files may be formatted based on a configuration defining the generation of the vectorized documents. For example, the structured files may be formatted based on a template of natural language text that includes variables that are replaced based on the corresponding data. The template may be repeated for each structured files and updated based on the corresponding data from the structured database.

Following step 220, the method of FIG. 2.1 may proceed to step 206 as discussed above.

FIG. 3 shows a flowchart of a method of using an online prompt-driven analytical model (OPAP) in accordance with one or more embodiments of the invention. The method shown in FIG. 3 may be performed by, for example, a data system (e.g., 130, FIG. 1.1). Other components of the system in FIG. 1.1 may perform all, or a portion, of the method of FIG. 3 without departing from the invention.

While FIG. 3 is illustrated as a series of steps, any of the steps may be omitted, performed in a different order, additional steps may be included, and/or any or all of the steps may be performed in a parallel and/or partially overlapping manner with other steps in other methods without departing from the invention.

In step 300, a user initializes with an identity and access management (IAM) system to identify a persona boundary associated with a user. The IAM may perform any authorization and/or identity detection on a user accessing the IAM via a computing device of a client environment (and via any network).

In step 302, an OPAP name associated with the persona boundary is obtained. The OPAP name may be obtained by mapping the user to a persona boundary. The OPAP name may be obtained using the OPAP model of the data system to identify the mapping, and identifying the corresponding OPAP name to the user. For example, the IAM may access the OPAP name using the hierarchical database of the OPAP model.

After the user is verified and authorized, and the OPAP name has been obtained, the user may communicate with the data system to issue user queries using the corresponding OPAP name.

In step 304, a user query for data associated with the structured dataset is obtained. The user query may be a natural language query that specifies obtaining, analyzing, or otherwise accessing data of the structured database and associated with the user.

In step 306, the OPAP name is identified for the user query. The OPAP name may be identified using the user query if the user query includes the OPAP name.

In step 308, the vectorized document(s) associated with the OPAP name are obtained using the OPAP model. In one or more embodiments, the OPAP name is cross-referenced to the OPAP model to identify the corresponding vectorized document. The vectorized document is obtained from the OPAP model.

In step 310, the obtained vectorized document(s) and the user query are applied to a LLM to obtain an output. In one or more embodiments, the output is in a natural language.

In step 312, the generated output is provided to the user via the corresponding client environment. The generated output may be provided by

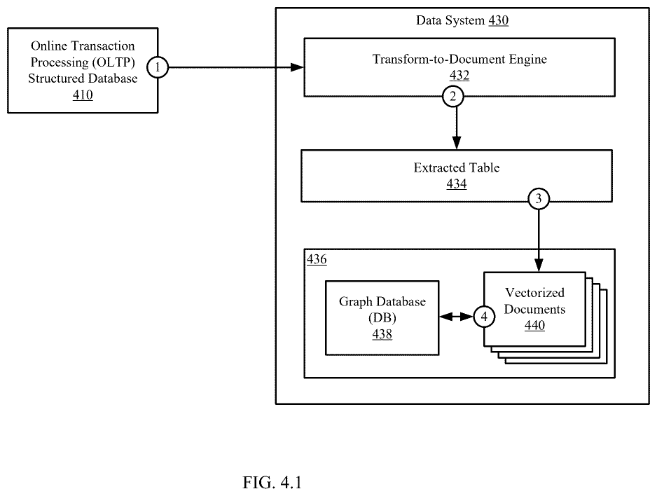

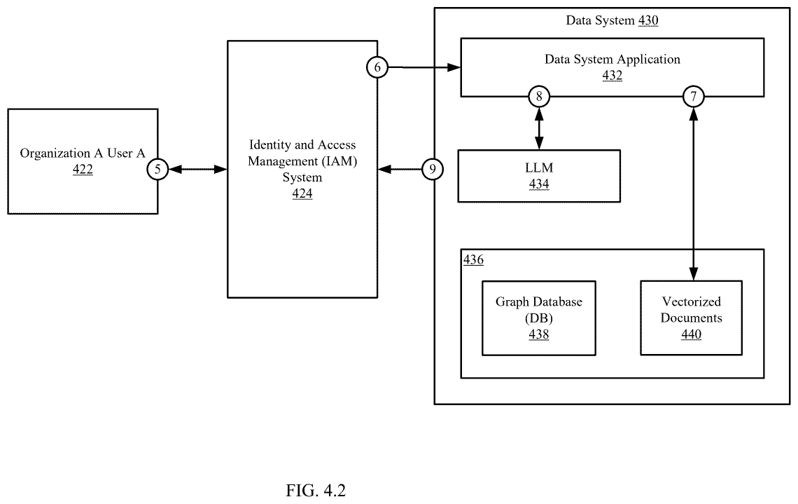

To clarify aspects of the invention described throughout this disclosure, an example is described below and illustrated using FIG. 4.1-4.2. In the below examples, actions performed by components of FIG. 4.1-4.2 are illustrated using circled numbers, and described below using bracketed numbers (e.g., “[1]”)

### EXAMPLE

FIG. 4.1-4.2 show a diagram of an example system in accordance with one or more embodiments of the invention. The example system includes an online transaction processing (OLTP) structured database (410) and a data system (430). The OLTP structured database (410) includes two tables: Tables A and B (not shown). Table A includes subscription data for users of Organization A and for users of Organization B. Table B includes drug trial data for both Organizations A and B. An administrator of a domain entity that owns the data system (430) may apply a configuration for an OPAP model that includes a hierarchy for two differentiating entities (Organizations A and B), and the sub-entities are separated based on subscriptions and drug trial data.

As such, the data system (430) implementing the configuration may use the two tables of the OLTP structured database (410) to generate the OPAP model (436) in accordance with FIG. 2.1-2.2 [1]. Specifically, the data system (130) may use a transform-to-document engine (432) to generate an extracted table (434) [2]. The extracted table (434) may include information about each of the columns in Tables A and B. One of the columns includes a company identifier that identifies each of Organization A and Organization B. This column is identified as the differentiating entity in the extracted table (434). Using the configuration of the differentiating entities and the extracted table (434), four persona boundaries are determined. The four persona boundaries may be identified using one of the following OPAP names: OrgA_Subscription, OrgB_Subscriptions, OrgA_Trial, and OrgB_Trial. The determination of the four persona boundaries are used to generate the vectorized documents (440) of the OPAP model (436). The vectorized documents (440) include four documents: Documents 1, 2, 3, and 4. Document identifiers are generated for each of the four vectorized documents (440). Each document is further associated with one of the four OPAP name corresponding to one of the four persona boundaries. In this example, Document 1 is associated with OrgA_Subscription, Document 2 is associated with OrgB_Subscriptions, Document 3 is associated with OrgA_Trial, and Document 4 is associated with OrgB_Trial. The vectorized documents are vectorized to obtain the vectorized documents (440) and indexed in the OPAP model (436).

Following the generation of the four vectorized documents (440), the graph database (438) (also referred to as a hierarchical database) is generated based on the relationships between the domain entity, the differentiating entities (i.e., the two companies), and the sub-entities [4]. The document identifiers, the components of the hierarchical database, and the OPAP names mapped to each vectorized document (440) are stored in the graph DB (438).

Turning to FIG. 4, a user of Organization A (422) desires to access trial data for analysis. Organization A user A (422) (also referred to herein as “user A”) is a drug trial scientist for Organization A who is intended to be able to access any trial data of Organization A.

At a first point in time, after the generation of the OPAP model (436) as discussed in FIG. 4.1, user A (422) logs into an identity and access management system (424) [5]. User A (422) is implemented as a client environment computing device. User A is assigned to one of the OPAP names, specifically the OPAP name “OrgA_Trial”. Following the log in, user A (422) uses the IAM system (424) to issue a user query to the data system (430) [6]. The user query specifies the question “Show me Alex's chronic disease status”. The requested information may be included in Document 3. A data system application (432) of the data system (430) obtains the user query and the OPAP name and refers to the graph database (438) to identify Document 3 as the corresponding vectorized document including the accessible data for user A (422). The data system application (432) obtains Document 3 from the OPAP model (436) using the corresponding OPAP name [7]. The user query and Document 3 are input to a LLM (434) of the data system (430) to generate an output [8]. The output may be a result of analyzing Document 3 to identify the requested data and generate a natural language response to the request of the user query. The natural language response is provided to user A (432) via the IAM system (424).

### END OF EXAMPLE

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

Embodiments of the invention may provide a system and method for securely and automatically managing the execution of data protection services between a backup server and one or more production environments across a network. Specifically, embodiments of the invention provide restoration services at an application-level for active directory applications. Such granular restoration services may be performed without requiring an agent to be installed in the production environment(s).

Further, embodiments disclosed herein enable the backup server to install listeners specialized in tracking changes to an AD application running in a virtual machine. The tracked changes may be used for incremental backups of the virtual machine. Such embodiments may provide granular level data protection of the virtual machines by tracking changes to the AD application within the virtual machine backup. The granular level data protection may further provide restoration services to AD objects of the AD application using the virtual machine backup in addition to using a separate AD application backup.

One or more embodiments of the invention reduce the resource consumption of AD application data protection by managing a number of AD listeners installed in the production environments executing the AD applications. The tracked changes may be used to manage the number by, for example, reducing the number of AD listeners if a rate of change is within a pre-defined range (e.g., below a threshold). The reduced use of resources may improve computing resource performance in the production environment.

Embodiments of the invention provide enhanced data search and data collection for users while maintaining data security. Embodiments of the invention enable management of a large structured database that collects data for a large set of users by segregating the structured database on a per-persona boundary basis. In this manner, users may utilize AI platforms such as a large language model (LLM) to query data associated with the user (based on the corresponding persona boundary) and obtain outputs without the LLM inadvertently using other uses'data for servicing the query. Said another way, embodiments of the invention prevent inadvertent access to data by a user. Embodiments of the invention may leverage the use of an identity and access management (IAM) system to determine a persona boundary of the user, and as such, the only data used for servicing the query by an LLM model is that which corresponds to the determined persona boundary. Such embodiments maintain data security and integrity in a system of distributed data and a large scale of users.

Thus, embodiments of the invention may address the problem of data security, data integrity, and access to large datasets in a distributed system. The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for managing data access, the method comprising:
obtaining, by a data system, a structured database from an order processing system, wherein the structured database comprises data associated with a large set of users;
after obtaining the structured database:
applying an initial table extraction on the structured database to obtain an extracted dataset, wherein the extracted dataset indicates a column of the structured database used for identifying persona boundaries;
performing a transform-to-document process on the structured database using the extracted dataset and based on a configuration to generate a set of vectorized documents, wherein each of the set of vectorized documents corresponds to one of the persona boundaries;
performing a graph embedding on the set of vectorized documents to obtain a hierarchical database;
loading the set of vectorized documents and the hierarchical database to an online prompt-driven analytical processing (OPAP) model of the data system; and
using the OPAP model and an identity and access management (IAM) system to manage access to the data by a user based on the persona boundaries, wherein the IAM system maps the user to a persona boundary of the persona boundaries.

2. The method of claim 1, wherein performing the transform-to-document process on the structured database comprises:
determining the persona boundaries based on the extracted dataset and based on the configuration;
generating the set of vectorized documents based on the persona boundaries;
populating each of the set of vectorized documents with a header, wherein the header of a vectorized document identifies the vectorized document;
populating each of the set of vectorized documents with a dimensional schema definition, wherein a dimensional schema definition of the vectorized document defines dimensions of the vectorized document; and
populating each of the set of vectorized documents with a set of structured files, wherein the set of structured files of the vectorized document comprise a dataset of the structured database accessible to a persona boundary of the vectorized document.

3. The method of claim 2, wherein the set of structured files are each generated based on a natural language template.

4. The method of claim 2, further comprising:
detecting a change to the data of the structured database;
identifying a persona boundary associated the change to the data;
determining that a vectorized document of the set of vectorized documents corresponds to the persona boundary associated with the change; and
updating one of the set of structured files of the vectorized document based on the change to the data.

5. The method of claim 1, wherein using the OPAP model to manage access to the data by the user comprises:
obtaining an OPAP name from the user via the IAM system, wherein the OPAP name corresponds to a persona boundary of the persona boundaries;
obtaining, from the user via a client environment, a user query for data associated with the structured database;
identifying, using the OPAP name, a vectorized document of the set of vectorized documents;
obtaining the vectorized document from the OPAP model;
applying the vectorized document and the user query to a large language model (LLM) to obtain an output; and
providing the output to the user.

6. The method of claim 1, wherein one of the persona boundaries is associated with a differentiating entity, a sub-entity of the differentiating entity, and a context of the sub-entity, and wherein the user corresponds to the differentiating entity.

7. The method of claim 6, wherein the hierarchical database specifies a domain at a highest level, the differentiating entity as a lower level to the domain, the sub-entity as a lower level to the differentiating entity, the context as a lower level to the sub-entity, and the one of the persona boundaries as the lowest level.

8. A non-transitory computer readable medium comprising computer readable program code, which when executed by a computer processor enables the computer processor to perform a method for managing data access, the method comprising:
obtaining a structured database from an order processing system, wherein the structured database comprises data associated with a large set of users;
after obtaining the structured database:
applying an initial table extraction on the structured database to obtain an extracted dataset, wherein the extracted dataset indicates a column of the structured database used for identifying persona boundaries;
performing a transform-to-document process on the structured database using the extracted dataset and based on a configuration to generate a set of vectorized documents, wherein each of the set of vectorized documents corresponds to one of the persona boundaries;
performing a graph embedding on the set of vectorized documents to obtain a hierarchical database;
loading the set of vectorized documents and the hierarchical database to an online prompt-driven analytical processing (OPAP) model of the data system; and
using the OPAP model and an identity and access management (IAM) system to manage access to the data by a user based on the persona boundaries, wherein the IAM system maps the user to a persona boundary of the persona boundaries.

9. The non-transitory computer readable medium of claim 8, wherein performing the transform-to-document process on the structured database comprises:
determining the persona boundaries based on the extracted dataset and based on the configuration;
generating the set of vectorized documents based on the persona boundaries;
populating each of the set of vectorized documents with a header, wherein the header of a vectorized document identifies the vectorized document;
populating each of the set of vectorized documents with a dimensional schema definition, wherein a dimensional schema definition of the vectorized document defines dimensions of the vectorized document; and
populating each of the set of vectorized documents with a set of structured files, wherein the set of structured files of the vectorized document comprise a dataset of the structured database accessible to a persona boundary of the vectorized document.

10. The non-transitory computer readable medium of claim 9, wherein the set of structured files are each generated based on a natural language template.

11. The non-transitory computer readable medium of claim 9, further comprising:
detecting a change to the data of the structured database;
identifying a persona boundary associated the change to the data;
determining that a vectorized document of the set of vectorized documents corresponds to the persona boundary associated with the change; and
updating one of the set of structured files of the vectorized document based on the change to the data.

12. The non-transitory computer readable medium of claim 8, wherein using the OPAP model to manage access to the data by the user comprises:
obtaining an OPAP name from the user via the IAM system, wherein the OPAP name corresponds to a persona boundary of the persona boundaries;
obtaining, from the user via a client environment, a user query for data associated with the structured database;
identifying, using the OPAP name, a vectorized document of the set of vectorized documents;
obtaining the vectorized document from the OPAP model;
applying the vectorized document and the user query to a large language model (LLM) to obtain an output; and
providing the output to the user.

13. The non-transitory computer readable medium of claim 8, wherein one of the persona boundaries is associated with a differentiating entity, a sub-entity of the differentiating entity, and a context of the sub-entity, and wherein the user corresponds to the differentiating entity.

14. The non-transitory computer readable medium of claim 13, wherein the hierarchical database specifies a domain at a highest level, the differentiating entity as a lower level to the domain, the sub-entity as a lower level to the differentiating entity, the context as a lower level to the sub-entity, and the one of the persona boundaries as the lowest level.

15. A system, comprising:
an order processing system;
an identity and access management system (IAM);
a client environment operated by a user; and
a data system comprising a processor, wherein the data system is programmed to:
obtain a structured database from the order processing system, wherein the structured database comprises data associated with a large set of users;
after obtaining the structured database:
apply an initial table extraction on the structured database to obtain an extracted dataset, wherein the extracted dataset indicates a column of the structured database used for identifying persona boundaries;
perform a transform-to-document process on the structured database using the extracted dataset and based on a configuration to generate a set of vectorized documents, wherein each of the set of vectorized documents corresponds to one of the persona boundaries;
perform a graph embedding on the set of vectorized documents to obtain a hierarchical database;
load the set of vectorized documents and the hierarchical database to an online prompt-driven analytical processing (OPAP) model of the data system; and
using the OPAP model and the IAM system to manage access to the data by the user based on the persona boundaries, wherein the IAM system maps the user to a persona boundary of the persona boundaries.

16. The system of claim 15, wherein performing the transform-to-document process on the structured database comprises:
determining the persona boundaries based on the extracted dataset and based on the configuration;
generating the set of vectorized documents based on the persona boundaries;
populating each of the set of vectorized documents with a header, wherein the header of a vectorized document identifies the vectorized document;
populating each of the set of vectorized documents with a dimensional schema definition, wherein a dimensional schema definition of the vectorized document defines dimensions of the vectorized document; and
populating each of the set of vectorized documents with a set of structured files,
wherein the set of structured files of the vectorized document comprise a dataset of the structured database accessible to a persona boundary of the vectorized document, and
wherein the set of structured files are each generated based on a natural language template.

17. The system of claim 16, wherein the data system is further programmed to:
detecting a change to the data of the structured database;
identifying a persona boundary associated the change to the data;
determining that a vectorized document of the set of vectorized documents corresponds to the persona boundary associated with the change;
updating one of the set of structured files of the vectorized document based on the change to the data.

18. The system of claim 15, wherein using the OPAP model to manage access to the data by the user:
obtaining an OPAP name from the user via the IAM system, wherein the OPAP name corresponds to a persona boundary of the persona boundaries;
obtaining, from the client environment, a user query for data associated with the structured database;
identifying, using the OPAP name, a vectorized document of the set of vectorized documents;
obtaining the vectorized document from the OPAP model;
applying the vectorized document and the user query to a large language model (LLM) to obtain an output; and
providing the output to the user.

19. The system of claim 15, wherein one of the persona boundaries is associated with a differentiating entity, a sub-entity of the differentiating entity, and a context of the sub-entity, and wherein the user corresponds to the differentiating entity.

20. The system of claim 19, wherein the hierarchical database specifies a domain at a highest level, the differentiating entity as a lower level to the domain, the sub-entity as a lower level to the differentiating entity, the context as a lower level to the sub-entity, and the one of the persona boundaries as the lowest level.
